(19) United States
(12) Patent Application Publication
(10) Pub. No.: US 2018/0060989 A1
(43) Pub. Date: Mar. 1, 2018

(54) System, method and device for digitally assisted personal mobility management

(71) Applicant: MaaS Global Oy, Helsinki (FI)

(72) Inventors: Sampo Hietanen, Helsinki (FI); Sami Pippuri, Espoo (FI)

(73) Assignee: MaaS Global Oy, Helsinki (FI)

(21) Appl. No.: 15/251,439

(22) Filed: Aug. 30, 2016

(51) Int. Cl. G06Q 50/30; G06Q 30/04; G06K 7/10; G06K 7/14; G01C 21/34; G06K 9/18

(52) U.S. Cl. CPC G06Q 50/30; G06Q 30/04; G06K 7/10722; G06K 9/18; G01C 21/3423; G01C 21/3484; G06K 7/1417

(57) ABSTRACT

“User terminal device for accompanying a user of the device while travelling in a geographic region served locally by at least one transport provider, such as a transport authority and/or transport operator, offering passenger transport such as public transport services therein, said terminal device being configured to receive and store a digital token containing digitally signed data and issued by a remote mobility management system trusted, by default, by the transport provider, said token being allocated to the user as a digital proof of the user's subscription to the system, wherein the token exhibits a temporally limited right to utilize the transport services within the region, said signed data being optionally established using a private signing key associated with the system, to transmit a number of wireless signals to the system, including signals indicative of the times and corresponding locations of device during the user's stay within the region to facilitate the system keeping track of the movement and related usage of transport services in the region by the user, and to indicate, responsive to a triggering event, the token including said digitally signed data wirelessly to a proximate verification apparatus associated with the transport provider, optionally other electronic mobile communication terminal device carried by an inspector or a stationary or vehicle-installed verification apparatus, to enable the verification apparatus to inspect the user's subscription based on the indicated token data and check the authenticity of the signature through the application of verification data associated with the system and preferably stored in the apparatus, said verification data optionally including a public key associated with the system. Related system and methods are presented.”

### FIELD OF THE INVENTION

Generally the present invention pertains to digital positioning, verification and communication technology.

Especially, however not exclusively, the present invention relates to digitally assisting and monitoring mobility activities of users carrying personal mobile communications devices during their various journeys such as vacations, commutes, business travel and basically any other trips.

### BACKGROUND

Mobility demand has increased drastically especially in urban areas during the last few decades. To cope with the demand, public transport and other transport services have been progressively scaled up, but a variety of associated challenges do still remain including but not limited to traffic jams, curfews, limited parking, pollution, underutilization or under allocation of resources, complexity of the available mobility schemes, lengthened journey durations, and obviously the related cost.

As outcome, traveling has become tedious if not annoying experience in many respects even if the considered users of available transport services are local and basically familiar with the neighborhood.

The situation is even trickier in scenarios where a person is just temporarily or occasionally visiting a region where he or she is supposed to move between locations and a complete reliance on some special private transport or common taxicab is not a desired option due to e.g. associated cost, accessibility of the target locations, traffic situation, etc.

Usage of many transport services such as most, if not all, public transport services is globally based on advance purchase of single, day or longer period tickets or passes, which enable one-time or limited period utilization of road, rail, or e.g. waterway transport services in the concerned area, respectively.

Acquisition of the aforesaid tickets or passes may be a burdensome exercise to many potential users such as visitors of the area. It may take a considerable amount of time to determine wherefrom the tickets or passes may be bought and what kind of tickets/passes are available and eventually suitable for the intended journeys, whereafter actually obtaining the tickets or passes from the related sales offices is still one further stressful exercise due to e.g. inconvenient locations, opening hours, queuing times or service language thereof. There may be several transport operators active in the same region in addition to a transport authority, which confuses a casual traveler even more.

After finally getting the necessary tickets or passes, some which may still later on turn out unnecessary and remain completely or partially unused if the travel plan changes, for instance, the traveler still has to learn how to use the local ticket stamping machines, etc.

In any case, the visitor has to be very active and even proactive in order to exploit the available transport resources successfully and effectively. Even then, lots of time and probably also money are lost in the process.

On the other hand, from the standpoint of the transport provider such as a transport operator (e.g. a bus operating company) or a transport authority, serving the great diversity of locals and visitors requires considerable human resources, facilities and hardware resources in terms of e.g. customer servants at dedicated service points and different ticket provision and validation equipment to be installed at transport vehicles, stations, etc.

Yet, contemporary usage analysis of the offered transport services for optimizing the same, which is based on monitoring e.g. ticket registrations at stamping or generally validation machines, yields somewhat limited results as it does not necessarily reflect the overall magnitude of usage and especially e.g. many finer details of the usage. Further, the obtained geographical sample may have rather coarse resolution depending on the number and distribution of the measurement points such as the aforementioned machines. Many useful statistics regarding (door-to-door) routes remain in the dark.

Digital tickets such as mobile tickets may provide a limited relief to some but not all of the aforesaid problems. Even if the traveler may omit physically visiting a ticket store or using a ticket vending machine, e.g. a network service of the transport provider, such as one of bus or rail traffic operator, may still have to be first identified and then accessed e.g. via a web browser for purchasing the necessary special, usually one-time, ticket prior to the actual utilization of the concerned transport service. This may also require registration in the concerned service provider systems and associated payment brokers, for example, which may be cumbersome and even difficult depending on e.g. the technical and linguistic skills of the particular traveler in question.

### SUMMARY

It is therefore an objective of various embodiments of the present invention to at least alleviate one or more afore-reviewed drawbacks relating to the prior art solutions where the utilization of transport services in various regions often requires acquisition of a bunch of local tickets, even one for each leg of a journey. This is particularly challenging from a standpoint of a casual user such as a tourist as explained hereinbefore. Also the analytics of the usage of transport services, billing, and implementation of necessary hardware, not forgetting the required human effort, would benefit from a novel approach overcoming the associated existing challenges.

Thereby in one resulting aspect, an electronic mobile communication terminal device, optionally a smartphone, phablet, tablet or wearable such as wristop type device, for being carried by a user of the device while travelling in a geographic region served locally by at least one transport provider, such as a transport authority and/or transport operator, offering passenger transport such as public transport services therein, is configured to

receive and store a digital token containing digitally signed data and issued by a remote mobility management system trusted, by default, by the transport provider, said token being allocated to the user as a digital proof of the user's subscription to the remote system, wherein the token exhibits a temporally limited right to utilize the transport services within the region,

transmit a number of wireless, preferably radio frequency, signals to the system, said signals being optionally transmitted at regular or intermittent intervals, said signals including indications of the times and corresponding locations of device during the user's stay within the region to facilitate the system keeping track of the movement and related usage of transport services in the region by the user, and

indicate, responsive to a triggering event, the token including said digitally signed data wirelessly to a proximate, optionally mobile, verification apparatus associated with the transport provider, e.g. other smartphone, phablet or tablet type device carried by an inspector, or a stationary or vehicle-installed verification apparatus, to enable the verification apparatus to inspect the user's subscription based on the indicated token data and particularly check the authenticity of the signature through the application of verification data associated with the system and stored in the apparatus preferably in advance.

In various embodiments, the verification data may include a preferably temporally limited and/or region-specific public key or other verification key associated with the system. The data may additionally or alternatively include a digital signing certificate associated with the system and issued by the system or a third party certificate authority. Signing the token data has preferably been executed using a corresponding private key in accordance with a selected PKI (public key infrastructure) scheme.

In accordance with one other aspect it is suggested an electronic system for providing digitally assisted personal mobility management service to users, wherein the system covers a number of, typically a plurality of, different geographic regions and operates in liaison with one or more transport providers offering passenger transport services in said regions, said system further being communication network accessible, preferably Internet accessible, and comprising one or more at least functionally connected servers, said system being configured to establish a digitally signed token to a user carrying an electronic mobile personal communication device for use as a digital proof of the user's subscription to the system, wherein the token exhibits a temporally limited default right to utilize the transport services offered by at least one transport provider within a region, preferably only within said region, of said number of regions, transmit said digitally signed token to the device of the user, provide digital verification data to the transport provider to enable checking the authenticity of the signature, receive signals transmitted by and/or regarding the device, including signals indicative of the times and corresponding locations of the device, the received signals optionally including inertial sensor data and/or transport mode data, determine based on the received signals information characterizing the user's and potentially other users' usage of the transport services within the region during the validity of the token, and supply the determined usage information to the transport provider preferably for analysis, verification, and/or billing purposes.

Various embodiments of the terminal device and/or of said one or more servers of the system may generally comprise at least one processing unit such as a processor or a microcontroller. Yet, at least one memory configured to store data including e.g. token data and functional logic data in the form of computer program code (defining e.g. a number of functional modules) executable by the at least one processing unit is advantageously provided. The code may be configured, when executed by the at least one processing unit, to cause the corresponding terminal and/or server device to perform one or more of the related above-mentioned activities. For implementing the associated information or generally data transfer, at least one communication interface, optionally a network interface, may be further included in the concerned terminal and/or server device, wherein e.g. a transceiver or a transmitter may be configured to transmit, or ‘send’, data, and/or e.g. a transceiver or receiver may be configured to receive data. In preferred embodiments, to indicate data such as token data visually e.g. to a user and/or a verification apparatus, the terminal device may include a display screen, optionally a touchscreen. Alternatively, the data may be indicated to the verification apparatus using a suitable communication interface thus applying e.g. radio frequencies for the purpose. In the case of especially terminal device, the utilized communication interface or interfaces, if a plurality is used, are preferably wireless.

Yet in a further aspect, a method to be executed by an electronic mobile personal communication device, optionally a smartphone, phablet, tablet or wearable such as wristop type device, for being carried by a user of the device while travelling in a region served by at least one transport provider, comprises: receiving and storing a digital token containing digitally signed data and issued by a remote mobility management system trusted, by default, by the transport provider, said token being provided to the user as a digital proof of the user's subscription to the system, wherein the token exhibits temporally limited right to utilize the transport services within the region, transmitting wireless signals including signals indicative of the times and corresponding locations of device to the management system to facilitate the system keeping track of the movement and related usage of transport services in the region by the user, and indicating, responsive to a triggering event, the token including said digitally signed data wirelessly to a proximate, preferably mobile, verification apparatus to enable the verification apparatus to inspect the user's subscription as indicated by the token data and check the authenticity of the signature through the application of verification data associated with the system and stored in the apparatus.

Still in one aspect, a method to be executed by an electronic system for providing digitally assisted personal mobility management service to users, wherein the system covers a number of different geographical regions and operates in liaison with transport providers offering passenger transport services in the regions, said system further being communication network accessible and comprising one or more at least functionally connected servers, comprises: establishing a digitally signed token to a user carrying an electronic mobile personal communication device for use as a digital proof of the user's subscription to the system, wherein the token exhibits temporally limited default right to utilize the transport services offered by at least one transport provider within a region of said number of regions, transmitting said digitally signed token to the device of the user, providing verification data to the transport provider, to enable checking the authenticity of the signature, receiving signals transmitted by and/or at least regarding the device, including signals indicative of the times and corresponding locations of the device, determining based on the received signals information characterizing at least the user's usage of the transport services within the region during the validity of the token, and supplying the determined usage information to the transport provider preferably for analysis, verification, and/or billing purposes.

In some embodiments, a data access portal embodied in an online system, such as server-operated Internet-accessible system, may be implemented to store and/or supply the usage information to a number of parties such as transport providers.

The utility of the present invention arises from a variety of issues depending on each particular embodiment. The end users such as tourists, other visitors or locals generally achieve a greater freedom to flexibly move around different regions using available transport services without a need to purchase different travel passes or tickets in advance to each region or even more commonly to each specific transport service, e.g. bus service or particular bus line, or just for a single leg, anymore. The service arrangement established by the embodiments of present invention, such as a mobility management system on the network side and user terminals on a client/user side, thus supplements or replaces, depending on the viewpoint taken, the traditional travel tickets or essentially ticket type passes with more dynamic option that requires minimum action and practically allows somewhat complete passivity from the users thereof. The users may subscribe to the suggested service operated by the presented mobility management system to be able to validly utilize transport services within a region without a traditional ticket acquired beforehand or during the concerned journey. Benefits for the transport providers include e.g. reduced cost, more accurate income distribution and more versatile data such as statistics available for capacity planning.

To achieve the above scenario, the mobility management system in accordance with an embodiment of the present invention preferably establishes first a general (being not associated with any particular end user/traveler) trusted relationship, or liaison, with a number of transport providers of each region. During the process, a number of persons being in charge of the system and regional businesses may naturally legally agree on the cooperation and conclude related contracts, but in a technical sense, which is one major question herein, the relationship is established by operatively connecting the electronic system(s) of the regional transport provider(s), typically including an at least conceptually centralized entity such as a service and/or server arrangement and a number of e.g. mobile, vehicle-installed and/or stationary verification apparatuses that may even include ordinary personal mobile terminals such as smartphones equipped with control software adapted for the purpose, and the mobility management system for enabling data transfer between them.

Thereupon, the system of a transport provider may be configured to preferably automatically obtain verification data from the mobility management system, e.g. from one or more databases thereof, over a communication network or networks, e.g. via the Internet and/or using private network(s). The verification apparatuses may then fetch or receive the data from the centralized part of the system of the transport provider e.g. over a communication connection or specifically, a communication network. Alternatively or additionally, the verification apparatuses may be configured to fetch or receive the verification data directly from the mobility management system.

The verification data may include e.g. key data such as a public key and preferably a signing certificate, when a private key has been used to sign token data through the application of an adopted encryption scheme, which may be one of the generally available PKI schemes or a proprietary one.

Various data obtained by the transport provider from the management system may generally concern e.g. the subscription of particular one or more users of the mobility management system and their locations and/or utilization of transport services within the region optionally during a selected time period such as reporting or billing period if the two differ. The transport provider (system) may, for example, send a data request to the mobility management system to receive subscription, location and/or mobility data (e.g. transport mode data and/or more detailed usage data, such as usage of certain transport line) regarding a queried user or generally a user account. Alternatively or additionally, the management system may be configured to automatically publish (e.g. online) or transmit similar data e.g. in the form of digital reports or other digital deliverables to the system of the transport provider.

In various embodiments, the true identities of the users (e.g. name) may be kept secret from the transport providers as the IDs used may be anonymous, being preferably anonymized by e.g. the management system or a selected external party. The user terminals may be configured to output anonymized ID to external verification apparatuses as well if desired. Personal information regarding the user in the form of e.g. user subscription, or ‘user account’, information may be stored in the mobility management system. A subscription may be associated with related anonymous ID that is still preferably unique, i.e. no other active user subscription is associated with the same ID. The anonymous ID may be then provided to the user terminal of the related user. In some embodiments, it may be a dedicated user ID code or be based on e.g. serial number or other ID of the terminal or mobility management client application running in the terminal. Accordingly, the possible privacy issues arising from transferring user related ID and/or movement (generally, behavioural) data may be handled in a satisfying manner, the actual approach taken still depending on the embodiment and e.g. enacted legal requirements in the concerned region. Location data may also be aggregated so as to further anonymize the identities, to avert determination based on single journeys by single users.

A token indicative of a valid subscription is in any case provided to a user terminal that is then configured to indicate the token to a verification apparatus for verification either based on real-time subscription validity inquiry sent to the mobility management system or previously stored verification data readily available at the verification apparatus, e.g. a public key and/or certificate associated with the mobility management system/service as discussed herein earlier. The token is preferably temporally limited. The period, or ‘duration’, of validity may vary depending on the embodiment and even within an embodiment. It could be, for example, one or few hours, a day, a week, or even a longer period. The duration may depend e.g. on the user (or user subscription details) and/or the concerned region where the token is applicable. The token preferably indicates at least the associated expiry time.

The user terminal is configured to transmit data, optionally substantially continuously, at regular intervals or intermittently (e.g. with dynamic timing responsive to transmission triggering events such as detected movement (e.g. translatory) and/or change of location and/or transport mode) indicative of the location and/or movement thereof to the mobility management system for logging and analysis including e.g. reporting and/or billing purposes.

Yet, an existing token may be revised, deleted or replaced with new one, or an additional token issued, in response to the data received at the mobility management system. A revised or new token may be transmitted to the terminal responsive to data signal received from the terminal and indicative of e.g. future location to be visited. The data signal may, in particular, indicate e.g. a travel plan (e.g. route or destination) to the management system.

When multiple, potentially different (e.g. bus, rail, waterborne, airborne), transport modes and related services are regionally managed e.g. by a single transport provider such as authority, even though may still be e.g. a plurality of other transport providers such as transport operators actually implementing the services in addition to or on behalf of said single managing provider, the aforementioned relationship may be established with such managing entity by the mobility management system. The related communication connections and schemes of communication for implementing the required data traffic between the two. Additionally or alternatively, the relationship may be established with a plurality of regional transport operators such as bus and/or rail transport service operators operating in the same region. Similar relationships may further be established with other modes of transport services including e.g. taxicabs.

Accordingly, as a user terminal is configured to provide location, user feedback and/or e.g. transport mode indicating data to the mobility management system, the management system can cleverly gather proof about the concerned user's whereabouts and e.g. utilized transport services. The nature and/or extent of utilization of transport services falling under e.g. the agreement between the transport provider(s) and the mobility management system in the region may be inspected. The system may determine e.g. billing details including the amount of financial compensation to be remitted to the transport provider accordingly. Also the actual payment may be triggered by the system. Further based on the extent of utilization, the concerned users' accounts may be debited. For instance, the user has to pay or otherwise compensate for the costs and e.g. a service fee arising from the used transport services.

As the system of the transport provider may, in turn, be configured to obtain, through fetching or receiving digital files, embodying e.g. reports or other form of deliverables, including indicia regarding the usage of their transport services by the subscribers of the mobility management service, the transport provider may technically optimize the transport services offered accordingly. For example, transport capacity may be increased or decreased at certain times, locations or lines if there seems to be undercapacity or overcapacity, respectively. A line may be re-routed and/or re-scheduled based on the usage statistics as another example of a corrective or optimization action responsive to the obtained usage statistics. Yet, through the mobility management system, the provider may validate the finances, e.g. the amounts remitted to the provider as a compensation for the utilization of the transport services used by the subscribers of the mobility management system.

Analysis, reporting, validation, and/or payments may occur e.g. at fixed (monthly, for example) and/or dynamic intervals. To enable flexible, on-demand, execution of different verification tasks by third parties such as the transport providers of a number of regions, the mobility management system may be configured to implement a validation service that is preferably network such as the Internet accessible, e.g. online service.

The present invention does not require substantial investments in new, dedicated infrastructure within each serviced region. For real-time verification of user subscriptions, e.g. ordinary smartphones or other mobile terminals, also stationary or vehicle-installed terminals when necessary, may be utilized, preferably provided with software adapted for the purpose with necessary verification logic and sufficient preferably wireless communication interface. The at least logically central or shared part of the system on the transport provider's side may be implemented by means of a number of server devices again provided with necessary functioning logic e.g. by means of suitable computer software.

Correspondingly, the mobility management system may be conveniently implemented utilizing e.g. a number of servers. The user terminals may, as well as the afore-discussed verification apparatuses, refer to smartphones, built upon e.g. Android™, iOS™, or Windows™ based platforms running suitable application software. The resulting use experience is thus very natural to a modern man in contrast to most ticket vending or validating machines, for example. The user may easily verify the status of his or her subscription before the mobility management service having regard to the current time and place (region) through inspecting the token data received and stored at the user terminal.

From the standpoint of minimizing manual workload, the mobility management system may be adapted to automatically, requiring no related control input from the user, issue a token for utilization of transport services within a region the user is staying at. This may be performed responsive to detecting a user (terminal) location within region. The user terminal may be configured to preferably automatically, without user input necessary, provide location data to the system for allocating the token and/or tracking the location and mobility of the user.

To additionally or alternatively allow also manual control, the token may be allocated responsive to receiving control input or token request at the mobility management service from the user e.g. via the user terminal. The terminal software, for example, may be provided with a UI feature such as an icon or other graphical feature, which can be selected by the user and causing sending a token request e.g. together with preferably automatically determined location estimate to the system.

Yet, the token may be allocated by the system upon receipt of the aforementioned digital travel plan indicative of the user's forthcoming presence in the region of interest. The plan may be established and transmitted by the user terminal or other equipment, e.g. some other terminal of a potentially different type (e.g. a desktop computer whereas the user terminal primarily carried along for utilizing the tokens/system is typically essentially mobile such as a smartphone or a tablet).

Receipt of the token may be indicated to the user by the user terminal via sound and/or visual (e.g. textual and/or graphical) message preferably representing token details such as period (e.g. expiry date/time) and/or area of validity. In some embodiments, e.g. transport service(s) the use of which falls under the token's scope and is thus, by default, authorized, may be correspondingly indicated.

Further benefits of different embodiments of the present invention will become evident to a person skilled in the art based on the detailed description below.

The expression “a number of” may herein refer to any positive integer starting from one (1).

The expression “a plurality of” may refer to any positive integer starting from two (2), respectively.

The verb “to comprise” is used in this document as an open limitation that neither requires nor excludes the existence of also unrecited features.

The expression “data transfer” may refer to transmitting data, receiving data, or both, depending on the role(s) of a particular entity under analysis relative a data transfer action, i.e. a role of a sender, a role of a recipient, or both. Similarly, the term “communicate” or related “communication” may herein refer to transmitting, receiving, or both transfer directions.

The terms “a” and “an” do not denote a limitation of quantity, but denote the presence of at least one of the referenced item.

The terms “position” and “location” are herein used generally interchangeably unless otherwise specifically noted.

### BRIEF REVIEW OF THE DRAWINGS

Different embodiments of the present invention are next described in more detail with reference to the appended figures, in which

FIG. 1 depicts selected major concepts of the present invention via few embodiments thereof and a related potential use scenario.

FIG. 2 is a block diagram of the system and electronic mobile personal communication device (user terminal) in accordance with respective two embodiments of the present invention.

FIG. 3 illustrates various embodiments of the present invention.

FIG. 4 is a flow chart of a method according to an embodiment of the invention.

FIG. 5 is a flow chart of a method according to another embodiment of the invention.

### DETAILED DESCRIPTION

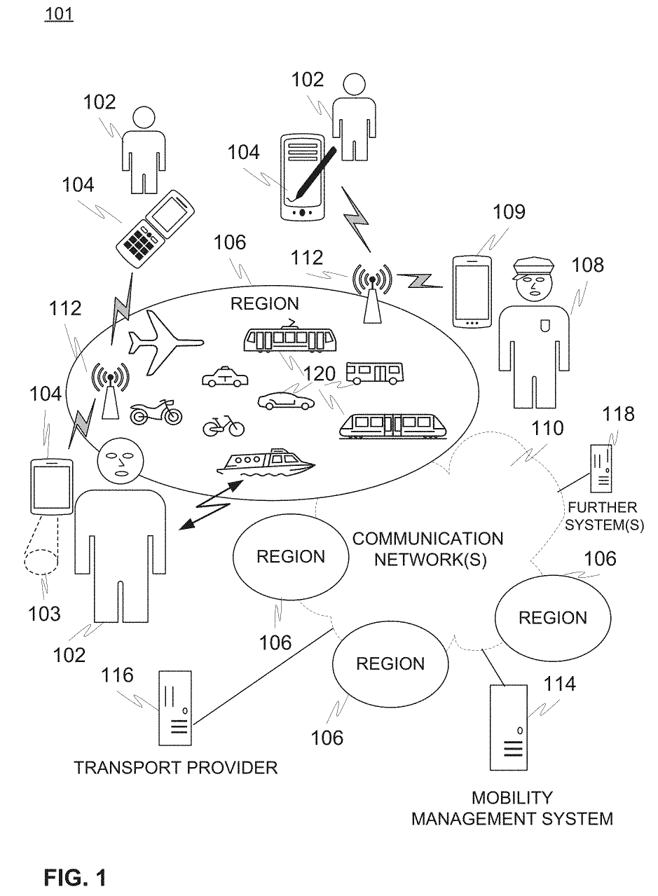

FIG. 1 illustrates (not in scale for clarity reasons), at 101, one possible use scenario of different embodiments of the present invention and various potential features of the concerned embodiments.

The mobility management service and related technical system 114, offering mobility management service to users 102 and typically comprising a number of at least functionally connected servers, may cover a plurality of different regions 106. The regions 106 may refer to e.g. geographical regions each served by at least one transport provider 116 via the related transport services 120, such as public transport and/or e.g. taxicab services, or even flights, offered in the region. The provider 106 is in liaison with the mobility management system 114 as already discussed hereinbefore.

In other words each transport provider 116 (there may be one or more), the system of which may contain e.g. a number of servers and e.g. a plurality of verification apparatuses 109, has agreed to allow the utilization of associated transport services 120, such as public transport services offered by the transport provider 116 within the region, by the users 102 (subscribers) of the mobility management system 114. Accordingly the related systems 114, 116 are configured so as to enable digital communication involving data transfer between them regarding e.g. user/subscription verification data/or and different reports or other electronic, essentially digital, deliverables typically establishing a data ensemble of desired kind.

The regions 106 may be mutually e.g. adjacent and/or remote. They 106 may be located in or defined by different cities, countries or even continents, for instance. Indeed, the region boundaries may follow e.g. existing administrative boundaries having regard to e.g. general administration (e.g. municipality limits) and/or transport services 120 offered. For example, a predefined, optionally geographically unite (not necessary though in all embodiments) service area served by the transport provider 116 may constitute a region of the system 114 with essentially the same borderline and/or general administration (e.g. municipality limits). The juristic person, e.g. transport operator or authority, underlying a transport provider 116 serving a region 106 may in some embodiments serve also a number of other regions or that single region only.

As readily understood by persons skilled in the art, the systems of different transport providers 116 may be but may not have to be physically located in the concerned regions 106 as modern communication technologies enable also positioning e.g. a management server and/or other equipment remotely from the related region 106.

A transport provider (system) 116 may further contain shared elements such as servers having regard to a plurality of regions 106 served by the same provider in terms of transport services. In that sense, the system 116 may contain thus contain exclusive and/or non-exclusive elements in view of a single region 106.

Also the mobility management system 114 may physically at least partially (e.g. one server of many) reside within one or more regions 106 served by it in terms of e.g. travel tokens 103 to be issued and forwarded to users (in practice e.g. sent to user terminals 104), and/or it 114 may at least partially be located outside any served region 106. In that sense the system 114 may be a single region-independent although it serves a number of, typically a plurality of, different geographical regions 106.

The user 102 visiting or knocking around the region 106 and utilizing the available transport services 120 such as public transport services and/or e.g. taxicabs, carries an electronic mobile personal user terminal (i.e. mobile personal communication device) 104 such as a cellular phone (preferably ‘smartphone’ capable of downloading and executing new application software, for instance), tablet, phablet, or applicable wearable electronics such as a wristop computer.

The user terminal 104 is provided with operation logic e.g. in the form of application software stored, or ‘installed’, in a memory of the terminal 104 and executed by one or more processing units of the terminal 104 for implementing a client end of the mobility management service suggested herein to the user 102. The software may be made downloadable from a remote source such as network service (e.g. web page) operated by a network server, for instance.

The terminal 104 stores e.g. a token 103 comprising a collection of data, which may be utilized to indicate to the user and/or verification apparatus 109 the prevailing status of the user 102 in relation to the system 114 and therefore consequentially also to the transport provider 116. For instance, subscription status, i.e. is the user's 102 subscription valid or not, from the standpoint of the system 114 and thus consequentially the transport provider 116, and/or an explicit entitlement to utilize the transport services within the current region 106 may be signaled with the token 103.

A single token 103 is optionally associated with one region of the user 102 only, typically but not necessarily being the current region 106 of the user 102 at the time of issue. It 103 may, for example, specify and exhibit the target, concerned region 106 to the user 102 and/or verification apparatus 109. To cover other region 106, the single token 103 may be updated or replaced with a new one. A token 103 is preferably associated with expiry time e.g. as a parameter stored therewithin. Upon expiration, the terminal 104 may delete it or just omit using it such as refrain from signaling it to the apparatus 109, for example. The terminal 104 may be configured to request new token 103 from the system 114. The system 114 may, on the hand, automatically issue and transmit a revised or new token upon the expiry of the previous one if the location data received from the terminal 104 still shows the terminal's presence in the region 106. In some embodiments, the mobility management system 114 may be configured to send a token revocation signal to the terminal 104 if, for example, the user 102 has cancelled his/her subscription. Correspondingly, the terminal 104 could be configured to send a revocation request to the system 114 for execution either automatically upon fulfillment of some selected condition or responsive to user input. In some embodiments, the user 102 could manually, via the UI of the terminal 104, instruct the terminal 104 to immediately delete the stored token 103 at least locally.

Nevertheless, the terminal 104 may be configured to store several tokens 103, each associated with different region 106, simultaneously. In some embodiments, a token 103 could be associated with a plurality of different regions 106. It could further indicate all the valid regions 106 to the user 102 or verification apparatus 109.

In various embodiments, the token 103 may comprise and/or indicate at least one element selected from the group consisting of: user id, anonymous or anonymized user id, signature established using a private key associated with the system, signature including a message digest obtained through hashing at least part of the token data content, expiry time, duration of validity, region of validity, shared secret such as symmetric key, issuer ID, image characterizing the region and/or transport provider (e.g. famous building or scenery, and/or coat of arms), graphical theme characterizing the region and/or transport provide (e.g. characterizing color(s) and/or pattern), and biometric evidence, optionally including a photograph or fingerprint data, representing the user. Optionally, the biometric evidence could be applied e.g. by the verification apparatus 109 to authenticate the person carrying the terminal 104 as the valid subscriber/user 102 (through e.g. comparison with real-life/on the spot—taken sample) to whom the token 103 was issued. The verification device may include a sensor such as a camera for measuring the property defining the biometric evidence for the associated verification.

For the intended communication with external elements such as one or more network infrastructures 110, including e.g. a mobile such as cellular network and/or a wireless LAN, which may both, in turn, connect e.g. to the Internet via which either or both of the systems 114, 116 may be reached, the terminal 104 preferably comprises a wireless communication adapter, or ‘interface’, typically incorporating a wireless transceiver, operable in such wireless network 110 using e.g. radio frequencies. The network 110 includes a number of wireless access providing devices 112 positioned within the region 106, preferably so as to establish good coverage according to the selected criterion, for interfacing the terminal 104 with the network 110 and other external elements 114, 118 accessible therethrough. The device 112 may include e.g. a base station or wireless access point (e.g. Wi-Fi hotspot). Accordingly, the terminal 104 is enabled to communicate with the mobility system 114. It 104 may be configured to transmit e.g. time, location, travel plan, sensor data, and/or transport mode indications to the system 114 for logging, analysis, reporting, and/or billing purposes, not forgetting the issuance of tokens 103. Some of the transmitted aforementioned data may be established at the device 104 and substantially immediately transmitted forward. Additionally or alternatively, local buffering may be applied e.g. based on applied transmission schedule and/or poor network coverage.

Some of the transmitted signals may be implicit considering e.g. included time and location indications. Namely, the location of the terminal 104 (and thus implicitly of the user 102 carrying it) may be determined on a network 110 side using e.g. triangulation based positioning technique applied to the signals not including explicit location data but still received from the terminal 104 by a number of network elements 112 in range, typically base stations of a cellular network. Alternatively, a coarser indication of the location may be obtained by identifying the particular cell or generally service area through which terminal 104 connects to the network 110, e.g. cell-ID in the case of cellular networks. As the base stations, wireless access points or other wireless access providing devices 112 are typically substantially fixedly positioned, their identity may be mapped into a coarse position estimate. This estimate may be established by the terminal 102 or connected network element 112, for example. Time, on the other hand, associated with e.g. a location estimate of the terminal 104 may be recorded from the time of receiving the signal(s) used for locating the terminal 104 unless the terminal 104 transmits explicit time data, which is also possible. Based on the received data, the system 114 may then analyze the usage of transport services 120 by the user 102 carrying the terminal 104 and/or issue e.g. the tokens that are preferably region-specific as thoroughly discussed herein elsewhere.

Yet, the terminal 104 may communicate with other external elements besides system 114, including e.g. a verification apparatus 109 to which the terminal 104 may be configured to indicate token data optionally automatically responsive to the receipt of interrogation (inquiry) signal from the apparatus 109 and/or responsive to a control input by the user 102 via the UI of the terminal 104 such as touchscreen. For the communication, the terminal 104 may apply the same technology as for communication with networks 110 or system 114. Alternatively, different still preferably wireless but potentially e.g. shorter range technology may be applied. The terminal 104 may comprise e.g. an active or passive radio frequency tag (e.g. RFID, radio frequency identification or particularly NFC, near-field communication), infrared, sound such as ultrasound, or Bluetooth™ based interface (e.g. classic Bluetooth or Bluetooth low energy compliant transceiver) for the communication. Or, the data to be wirelessly communicated may be visualized on a display screen of the terminal 104 optionally utilizing e.g. numeric, alphabetic, or alphanumeric characters, and/or a barcode, matrix code or other graphical code, which is then read optically, typically by a camera, of the verification apparatus 109. The visualization is preferably constructed such that the selected visual encoding method is understood by the apparatus 109 and can be decoded thereat or at least in a further apparatus such as network element functionally connected thereto 109.

The verification apparatuses 109 may refer to mobile personal communication devices (terminals) carried by ticket inspectors 108. One feasible hardware implementation is a contemporary cellular phone, or specifically smartphone. The memory of the apparatus 109 is preferably provided with software for controlling e.g. processing, communication and optionally imaging features of the apparatus 109 so that the token 103 can be read from a user terminal 104, inspected and verified. The inspection may refer to visual inspection of token data rendered on the display of the apparatus 109. Preferably the validity of the token is additionally or solely verified computationally using a selected method of cryptography. For example, token data may be signed using a private key associated the system 114 and later verified using the corresponding public key provided to the apparatus 109 e.g. over a wireless connection from a remote element such as mobility management system 114 or a network element, such as a server, of the transport provider (system) 116.

In addition to or instead of mobile terminal type verification apparatus 109, a substantially stationary, e.g. fixedly installed, implementation thereof is fully feasible having regard to e.g. gate-type installation at traffic station, platform or stop. The apparatus 109 may even be integrated with existing ticket validation machines. The apparatus 109 thus may but does not have to be manned as it may act completely automatically and read e.g. optically or using radio frequencies token data from the terminals 104. Based on the outcome of the verification action, a number of response signals may be issued by it 109.

One possible response signal may include a local control signal to control e.g. a gate through which the user 102 desires to enter (successful verification translating into opened gate). Additionally or alternatively, a signal may be sent e.g. over communication network(s) 110 to a remote element such as a network server of system 116 and/or mobility management system 114 to indicate verification action and e.g. its outcome (success/failure). As an additional or alternative action, a signal may be issued back to the terminal 104 to indicate the outcome of verification and e.g. related message. E.g. “Subscription to an allowed mobility partner validated. Have a nice trip!” type message may be issued in the case of success.

Yet, a number of further systems 118 may be connected to network(s) 110 and therethrough to other elements such as terminals 104, apparatuses 109, mobility management system 114 or transport provider systems 116 for data transfer. These systems 118, containing e.g. a server, may include e.g. online payment or billing systems, transport mode determination systems, certificate authorities, authentication systems, and/or positioning systems. Some of the needed functionalities regarding e.g. billing of subscribers of system 114 or payments by the system 114 to the transport provider 116 based on the utilization of transport services, may be at least partially executed by these systems 118.

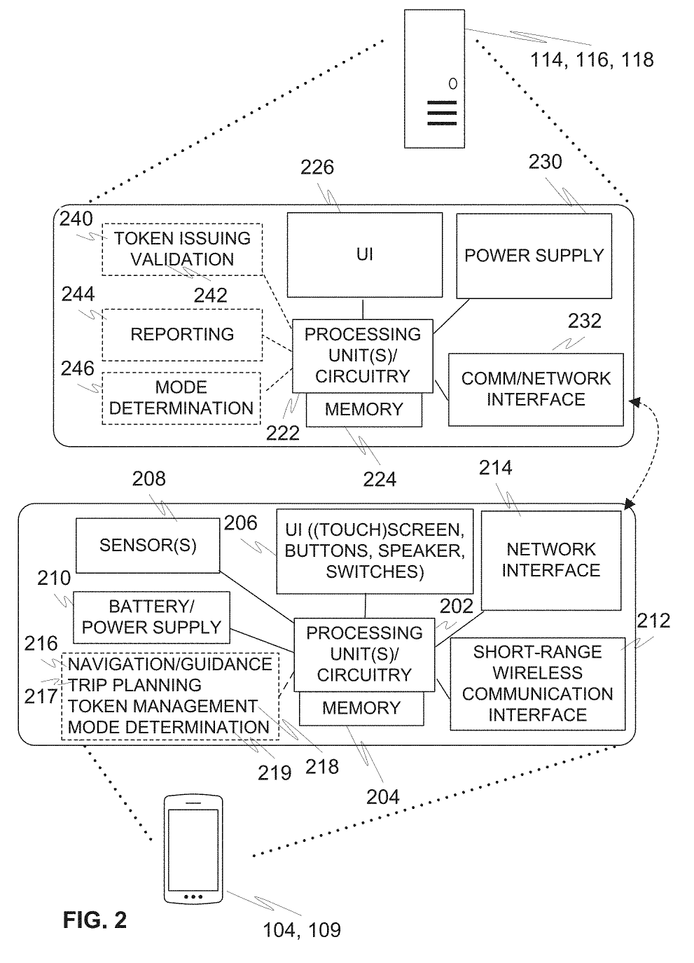

FIG. 2 represents block diagrams of the mobility management system 114 and user terminal device 104 in accordance with respective two embodiments of the present invention.

In the upper half of the figure, an embodiment of the system 114 is shown. However, with the likely exception of e.g. processor-executable and somewhat use-specific software elements 240, 244, 246 depicted using broken lines, similar implementation could be applied, mutatis mutandis, to at least parts of the system 116 (e.g. network accessible server) and/or system 118 as well as being easily understood by a person skilled in the art.

At least one processing unit 222, or ‘processor’, such as at least one microprocessor, microcontroller, digital signal processor, or generally similar circuitry, may be included. The processing unit 222 may be configured to execute instructions embodied in a form of computer software (e.g. application program) stored in a memory 224, which may refer to one or more memory chips or generally memory units separate or integral with the processing unit 222 and/or other elements. Preferably at least part of the memory 224 is rewritable, such as RAM (random-access memory) or other volatile memory to enable dynamic storing of new data therein. At least part of the rewritable memory may be non-volatile such as flash so that it retains its state and thus data without relying on a power supply 230 in the meantime. The power supply 230 may include e.g. a transformer electrically connectible to the mains or at least a connector therefor.

The software provided in the memory 224 may be configured so as to instruct the processor unit 222 to execute a number of tasks relevant to the provision of mobility management service as generally described herein. Accordingly, the system 114 may implement a number of functional modules including but not limited to e.g. issuance of tokens 240 including signing, validation of tokens 242, reporting 244 (e.g. to the transport provider(s) on the detected usage of their transport services during a related reporting period, e.g. one month, and/or regarding e.g. ongoing usage), and/or transport mode determination 246. Indeed, these and possible other functional modules refer to functional ensembles that could also be physically realized in a variety of other ways depending on the embodiments, e.g. either by larger ensembles covering a greater number of functionalities or by smaller ensembles concentrating on a fewer number of functionalities, as being certainly understood by a person skilled in the art. The modules may generally contain program code such as instructions and other data stored in the memory 224, the actual execution of which may be then performed by the at least one processing unit 222.

In some embodiments, a computer program product comprising the aforementioned software may be provided. The software code may be embodied in a non-transitory carrier medium such as a memory card, an optical disc or a USB (Universal Serial Bus) stick, for example. The software may be transferred as a signal wiredly or wirelessly from a transmitting element to a receiving element.

A UI (user interface) 226 may be provided to enable the necessary control and access tools to an operator of the system 114 for controlling the related functionalities and verifying the related statuses as well as for inspecting the gathered, possibly analyzed and processed, data such as user subscription data, token usage data, transport services usage data, billing data having regard to the users (usage of the mobility management system may indeed be subject to a fee, such as fixed and or dynamically determined, e.g. transport services usage based, fee), and/or payment data having regard to the liaisons, e.g. transport provider(s) 116, to be compensated for allowing the users 102 to utilize the transport services they offer or have in their control.

The UI 226 may include a number of local components for user interactions such as data input and/or output. For data input, the components may contain a keyboard, keypad, a touchscreen, a mouse, a touchpad, and/or a microphone. For data output, the components may include a (touch)screen, a speaker, an indicator light, a tactile output device such as vibrating element, and/or a data projector.

The UI 226 may alternatively or additionally provide remote input and/or output optionally via a web interface, preferably web browser interface, which may further involve the usage of communication interface 232. The system 114 may thus host or be at least functionally connected to a web server, for instance.

The depicted communication interface(s) 232 refer to one or more data interfaces such as wired network (e.g. Ethernet) and/or wireless network (e.g. wireless LAN (WLAN) or cellular) interfaces for interfacing a number of external devices, such as mobile terminals 104, systems and/or networks with the system 114 for data transfer. The interface 232 may include an applicable transceiver or a separate transmitter and receiver. The system 114 may be connected to the Internet for globally enabling easy and widespread communication therewith.

It is straightforward to contemplate by a skilled person that when an embodiment of the system 114 comprises a plurality of at least functionally such as communication-wise connected devices, such as servers, any such device may contain a processing unit 222, memory 224, and e.g. communication interface 232 of its own for enabling execution of local processing tasks and mutual and/or external communication.

In the lower half of the figure, an embodiment of the mobile user terminal 104 is shown. A generally similar implementation could be applied, mutatis mutandis, to the verification apparatus 109 with the exception of e.g. at least partially different functional (typically software defined/controlled) modules depicted using a broken line.

Again, with reference to the above description and illustration of system elements, at least one processing unit 202 and memory 204 for storing operation logic e.g. in the form of processor-executable software application (code) may be provided. A number of functional modules may be thus implemented by related software stored in memory and executed by the at least one processing unit 202. A computer program product preferably embodied in a non-transitory carrier medium may be provided to accommodate and transfer the software.

The aforesaid modules may include e.g. navigation and/or guidance 216, trip planning 217, token management 218 (e.g. responsible for requesting a token, storing a received token and/or indicating the token to the user and/or verification apparatus), and/or transport mode determination 219 modules.

A number of sensors 208 may be included in the terminal 104 for positioning and/or transport mode determination purposes. The sensors 208 may include at least one inertial sensor, such as a gyroscope, accelerometer (e.g. 2-axis or 3-axis), and/or a magnetometer.

The sensor signals may be input to a selected processing method, such as positioning and/or transport mode determination method. Alternatively or additionally, the sensor data may be transmitted to remote elements such as the mobility management system 114 for processing and analysis such as transport mode determination.

For e.g. satellite-based positioning, a positioning signal (e.g. GPS and/or GLONASS) capable receiver and related computation logic may be included in the terminal 104. The related hardware and software may be conceptually included e.g. in the sensor block 208.

The power supply 210 may refer to a preferably rechargeable battery, such as Li-ion battery. This is a preferred solution in the case of mobile devices. In the embodiment of a fixed or vehicle-installed, verification apparatus 109, the supply 210 could include e.g. a connector to the mains.

The UI 206 may include, as above, various interaction means for input and output. A touchscreen, ordinary screen, an indicator light, a button, a keypad, touchpad, a switch, a button, a speaker, and/or a microphone may be utilized. How different UI features may be capitalized in connection with token related actions, has been dealt with via examples provided elsewhere herein. Further, in some embodiments the UI could be applied to input user feedback regarding the (use of the) system 114 or related issues. The obtained feedback, e.g. textual (optionally comment) and/or numeric feedback (e.g. grade given using a predefined scale), could be then forwarded to the system 114 for service optimization and/or user satisfaction tracking purposes, for example.

A network interface 214 such as a cellular and/or wireless LAN compliant transceiver (or a transmitter and a receiver, depending on the desired hardware implementation) may be provided for communicating with associated network infrastructures and elements reachable therethrough such as the aforesaid mobility management system 114. E.g. location, time, transport mode, sensor and/or token data may be transferred via it 214.

Yet, e.g. a second, preferably short(er) range wireless communication interface such as a tag or e.g. Bluetooth™ based transceiver may be optionally provided for communication with e.g. a verification apparatus 109. The verification apparatus 109 thus preferably comprises a functionally compatible counterpart such as a tag (reader) or another (Bluetooth) transceiver. Alternatively, in some embodiments a common interface 214, such as a common wireless transceiver, could be utilized for communication with the system 114 and verification apparatus 109.

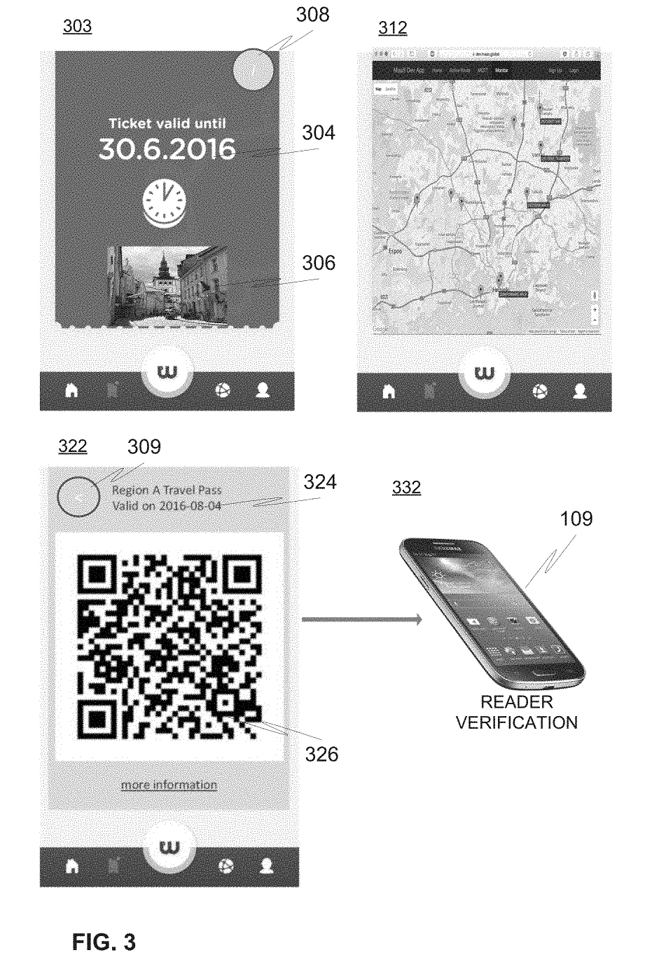

FIG. 3 further illustrates various potential features of the preferred embodiments of the present invention.

Screen views at 303 and 322 illustrate the corresponding embodiments of token data visualized on a display screen of user terminal 104 or verification apparatus 109 after receiving the data from the terminal 104.

The on-display visualization 303 of token data, preferably controlled by the functional module 218, may include basically any of the data elements included in the token 103. Temporal indication of validity such as expiry time 304 may be indicated graphically, alphabetically, numerically and/or alphanumerically, for instance. Preferably the indication 304 is rendered sufficiently large, potentially centrally positioned and generally just distinctive enough to enable rapid visual adoption by the user 102 and/or inspector 108. Yet, the visualization 303 may indicate the region 306 in question e.g. alphabetically (‘Boston’) and/or graphically using e.g. a photograph or other image characterizing the region. A related scenery, building, plant, animal, coat of arms, or event could be illustrated.

The constructed view 303 may be provided with a number of control input (UI) features 308 such as user selectable icons (software buttons) or other selectable displayed elements associated with predefined functions for enabling e.g. switching between different states or modes of the associated token management or generally mobility management client software, such as between different visualizations 303, 322 of token data. Generally similar user selectable UI feature(s) could be additionally or alternatively configured to trigger wireless token data transfer to a verification apparatus 109 or transmission of location estimate to the system 104.

The machine readable (optically readable) visualization 322 of token data may optionally include human readable or generally adoptable portions such as textual portions 324 indicative of e.g. region and time of validity of the token in addition to at least one portion 326 specifically optimized for machine reading, at 332, by a camera or generally reader of the verification device 109. The portion 326 may include e.g. a barcode or matrix (2d) code of a predefined format, including selected if not all token data such as the region, expiry time, etc. The data represented by portions 324 and 326 may thus at least partially if not completely overlap. The UI view 322 may also include a number of control input features 322, such as an icon for switching to other view, e.g. view 303, and/or an icon for sending the token to a verification apparatus 109.

In addition to or instead of optical imaging and pattern recognition based transfer of token data from the terminal 104 to the apparatus 109, some other wireless technique typically utilizing e.g. radio frequencies may be applied. For instance, tag technology may be applied. In one related embodiment, the terminal 104 may be configured to monitor the presence of an interrogation signal or specifically, receipt of a token inquiry message, from the apparatus 109 in response to which the terminal 104 is further configured to wirelessly provide token data for verification.

The transmission of the token data may be automated from the standpoint of the user 102 who may then omit manually triggering the transfer of token data to the apparatus 109, for example. In some embodiments, however, at least limited manual intervention may be considered advantageous so that the user may retain a desired level of control over the transfer of token data. For example, based on detecting a token inquiry by the apparatus 109 at the terminal 104, the user 102 may be prompted e.g. via the display screen of the terminal 104 to authorize the transfer by related control input.

As also described herein elsewhere, the user terminal 104 may in some embodiments be configured to trigger, preferably automatically, the transmission of a signal via the wireless transmitter 214, the signal being directly or indirectly (implicitly) indicative of e.g. the current and/or past location(s) of the terminal 104 and assumedly thus also of user 102 supposedly carrying the terminal 104. The signal is typically directed to the mobility management system 114.

In case e.g. poor or non-existent network coverage or prevalence of other predefined condition prevents sending the signal, the data to be included in the signal such as location data, preferably also time data (i.e. times and corresponding locations of the terminal 104 being linked together) may be buffered in the terminal 104 and transmitted forward upon detecting the occurrence of a selected transmission condition, such as sufficient network coverage.

In some embodiments, the terminal 104 may be provided with a UI feature such as selectable icon on a touchscreen or physical button to enable the user to specifically trigger sending a token request and/or indication of the current location of the terminal 104 to the system 114. Preferably the token request includes a location estimate. Such UI feature may be visualized with symbolic and/or textual notifier of the underlying function (e.g. icon with superimposed or neighboring text ‘Order a travel token’). Optionally, the user-selection of the UI feature activates the execution of an location estimation procedure relying on e.g. received positioning satellite signals and/or wireless access providing device identities (e.g. cell-ID). Supplying the receiving system 114 with explicit token request, it is indeed made fully known to the system 114 that the user 102 really is after a token for the utilization of the local transport services within the currently visited region 106, whereupon fulfilling the request may be prioritized (executed first, for example) over e.g. mere location indications received from other terminals 104 without explicit user-initiated token requests.

Wireless signals as discussed above may be transmitted by the terminal 104 and/or analyzed for positioning, transport mode determination, token management, transport service usage tracking and/or other purposes by an external element such as the mobility management system 114 at intervals, such as regular and/or intermittent intervals.

Having regard to the applicable intervals, the interval may be e.g. few minutes only, potentially falling within a range from about three to 45 minutes, thus being e.g. 5, 15 or 30 minutes. The interval may still be dynamically re-configurable e.g. by the user 102 and/or remotely the system 114. In some embodiments, the interval could be considerably longer, e.g. one day, or shorter, e.g. a minute or two, or less basically implying substantially continuous activity from the standpoint of the suggested solution.

As mentioned herein earlier, the signals transmitted by the terminal 104 may be arranged to explicitly indicate location (e.g. based on GPS and/or GLONASS, i.e. ‘GLObal NAvigation Satellite System’, data received by the terminal 104), or the signals may be in principle silent on the location, while still enabling and being used for determining the location based on e.g. triangulation. As a further option, e.g. identification data and previously known position regarding a connected network access providing device (e.g. a base station or a wireless access point) 112 may be utilized to determine and/or indicate the location of the terminal 104 either by the terminal 104 itself, by the system 114 and/or by other element, e.g. external (positioning) system 118. Naturally the terminal 104 and/or other elements such as system 114 performing positioning tasks may even support several of the available positioning options and select the used one e.g. case-specifically (e.g. most accurate option available) or apply them simultaneously, i.e. combinatorially, or alternately. Generally, various methods of handset-based positioning, network-based positioning and/or hybrid positioning are applicable also in connection with different embodiments of the present invention.

In particular, the mobile terminal may be thus configured to determine its location based on at least one element selected from the group consisting of: satellite positioning signal, GPS signal, GLONASS signal, wireless network signal, cellular signal, wireless LAN signal, inertial sensor, camera image and/or view, tag signal received, and audio signal captured via a microphone.

The role of inertial sensor data in positioning is usually supplementary. Through the analysis of e.g. acceleration (amount and direction), the accuracy of e.g. GPS signal based positioning may be enhanced and e.g. the general update rate of location estimates increased.

With reference to the aforesaid camera data, a selected pattern recognition procedure could be applied to the obtained images or real-time camera view to detect known objects (e.g. buildings, bridges, sceneries, fauna, flora) with known locations therefrom. The recognition may further include e.g. character recognition/image to text conversion. E.g. text on a street sign could be identified and utilized as or translated into a position estimate.

With reference to short-range communicated data such as data contained in a captured radio frequency tag signal, the data could itself indicate some location or be associated to a certain location based on an available cross-linking database.

With reference to audio data, the captured audio could be subjected to sound analysis such as sound recognition, voice recognition and/or speech recognition, linking the sound to some particular location where the sound is e.g. typically present (e.g. the characterizing (bell) sound of ‘Big Ben’, i.e. famous clock tower, could be recognized and linked with certain location in London). From the speech extracted, location information could be derived as well (‘We are now in London’).

It shall be mentioned here just for the sake of completeness that notwithstanding the actual transmission instants and related intervals of wireless signals indicative of e.g. token request, location, time, sensor and/or transport mode data as discussed hereinbefore, the location and/or other transmitted information could be first determined in the terminal 104 at regular or intermittent intervals (dynamically) as well. The determination interval could be substantially equal to the one of the transmission but there are also alternatives. For instance, the determination interval could be shorter than the transmission interval. In the transmission, several past determinations could be then included (batched).

The utilization of intermittent intervals for determining the position, some other information, and/or actual transmission instant thereof may naturally refer to the application of dynamic intervals. For example, a number of triggering events may be defined by the user 102 via the terminal 104 and/or, more typically, by the system 104, the occurrence of which shall be then monitored and detected as a requisite. One potential triggering event for the transmission may be associated with monitoring the (geo)location of the terminal 104 and provided that the location fulfills a selected criterion or criteria, sending the signal. The criterion may stipulate e.g.that the location of the terminal 104 must have changed sufficiently from the last known (indicated) location. The associated threshold distance, or generally criterion for the fulfillment of triggering event, may be defined e.g. in terms of kilometers or other units of length, a switchover to a new wireless access point or base station or to a new network, a change in the IP address or other network address, and/or a switchover to new country, city or other predefined region such as a service region of the system 114 and/or transport provider. Similar condition events, such as switchover or ‘handover’ to a new network, switching between modes (e.g. turning on or off) of the terminal or related application (e.g. mobility management application), may be monitored for triggering the actual determination of the position and/or other information.

As one additional or supplementary general condition for conducting tasks such as positioning or data transmission, it could be required that the task should occur at least once within a selected default period. This kind of basic temporal ruling could be applied in addition to other parallel, alternative criteria so that the task nevertheless occurs at least once per a default period even if other conditions are not met. Then the fulfillment of alternative criteria may basically only shorten the period.

In some embodiments, the user 102 may be provided with option to transmit, e.g. via the terminal 104 or other applicable device such as a desktop computer back at home or office, a travel plan to the system 114 to enable or cultivate token management. The travel plan shall include at least one likely future location of the user 102, preferably the overall travel route with related time span.

At 312, a map type or generally graphical type representation of an area covering at least part of e.g. a number of regions 106 is shown. Generally a similar UI view could be provided on the screen of the terminal 104 for facilitating travel planning, route planning, navigation, and/or positioning by the user 102. The terminal 104 may be supplied with at least one related (software) tool for the aforementioned purposes. Preferably the UI is indeed graphical but it could alternatively be at least primarily textual. If not being used in stand-alone fashion, e.g. the mobility management system 114 or some other functionally connected remote system 118 could be configured to provide the necessary additional processing functionalities.

In the associated use scenarios, the terminal 104 may be configured so as to enable the user to select, via the UI, a number of locations e.g. on a depicted digital map (e.g. a street or some other type of a map) and optionally define a number of travel routes therebetween.

The tool may be configured to determine one or more route suggestions between the selected locations, or e.g. a selected location and current location.

The shown digital map may be generally configured to indicate the current or last determined location of the terminal 104 via a visually detectable object such as a circle, dot or star thereon, or by centering the map on the location.

The tool may be configured to suggest e.g. different transport services for use in order to reach the locations according to selected, optionally user-changeable, criteria such as shortest travel time or shortest distance. The tool may incorporate a database storing information on the transport services available in the region, associated routes, schedules, traffic situation and/or weather information. The database may be applied in navigation and/or route determination. Yet, the tool may apply and/or exhibit knowledge about the contractual situation regarding the services, i.e. can they be freely used based on a valid subscription to the system 114, or should the subscription be updated or some form of external authorization (e.g. traditional printed or digital tickets) be acquired for exploiting such.

Having regard to potential navigation feature offered by the tool, a proprietary or already available third party solution may be adopted to provide the related real-time visual and/or audible guidance, preferably with real-time route adaptation (re-routing) based on e.g. missed or misinterpreted previous navigation instructions and/or a challenging or changing traffic or weather situation.

As being thoroughly contemplated herein, based on the obtained location estimate associated with the terminal 104 and the user 102 carrying the terminal 104, the system 114 is configured to preferably automatically issue a number of related tokens 103, e.g. one per indicated location-containing region 106.

The issued token 103 may be immediately valid and thus applicable as a proof of a user's 102 subscription to the system 114, thus enabling also immediate utilization of transport services in the concerned region 106. In some embodiments, however, the token 103 may have a specifically defined starting time, or e.g. starting condition, associated therewith and constituting one element thereof. Accordingly, the token 103 may be provided to the terminal 104 beforehand. The terminal 104 and especially token management logic 218 therein may be configured to automatically, and/or responsive to user input via the UI, to execute switchover to or from the use of a certain token. In automated switchover, e.g. token related time data (starting time and/or expiry time) and/or location data (when the token-related region is entered or exited) may be exploited by the control logic executed in terminal 104. The ‘use of a token’ may in this context refer to e.g. indicating the token 103 to the user 102 or verification apparatus 109.

In some embodiments, the system 114 may postpone providing (and optionally also creating) a token to the terminal 104 until a service region 106 containing the indicated (future) location based on e.g. a received travel plan is really entered or about to be entered by the user 102 in the light of e.g. obtained location estimate of the terminal 104 and/or time of arrival indicated in the travel plan. Not until the fulfillment of a related condition, the region-related token 103 is transmitted to the terminal 104.

The token 103 is preferably, besides location (region) and time limited, also personal and thus associated with the user 102 and/or his terminal 104. Advantageously, the association is such that the token cannot be validly transferred or copied between several users/terminals, or at least such activity can be detected and verified later e.g. by the verification device 109. This may be enabled by including e.g. in the token data an identifier such as a target user (ID), application ID (e.g. serial), biometric data, and/or device ID (terminal), which may be also verified by the verification apparatus 109 and/or inspector 108 through e.g. comparison of token included data with other available data stored e.g. in the application 218, terminal 104, and/or measurable from the user (e.g. subscription card or other proof of user identity, or measurable biometric property such as facial image, iris characteristics, or fingerprint).

The token 103 may be stored as at least one digital file or generally a collection of data. The token 103 is first issued by the system 114 and then transmitted to the terminal 104 via the intermediate communication network(s) 110 such as the Internet and e.g. connected cellular network or local area network. The token 103 is digitally stored at the terminal 104 for use as a digital proof of the user's 102 subscription to the system 114. The software 218 installed at the terminal 104 may then take control over managing the token 103 (e.g. storing, indicating, deleting) according to predetermined logic.

For constructing the digital signature included in the token 103, e.g. PKI infrastructure (public key infrastructure) or other generally applicable and recognized digital signing methodology may be utilized by the system 114. Preferably the used signature is of timestamped type. To create the signature, e.g. one way hash of the data to be signed (one or more data elements of the token including e.g. region indication and expiry time indication) may be established. Thereafter, the resulting hash or digest may be encrypted using a private key associated with the system 114. Thus the signature may contain at least the encrypted hash and optionally e.g. indication of the used hashing algorithm.

In addition to providing the token 103 to the terminal 104, the system 116 may be provided with access, e.g. via a message and/or through online interface, to the related public key and e.g. digital signing certificate so that the system 116 and specifically e.g. the verification apparatus 109 may validate the signature and thus the token 103. The certificate associates the public key with the identity of the system 114 and preferably includes the signature of the certificate-issuing authority. The certificate may be issued by the system 114 itself or a selected reputable (e.g. well known and generally trusted) external entity 118, e.g. a certificate authority. The potential timestamp of the signature may be compared against available verification information such as the validity period of the certificate.

In preferred embodiments as alluded to hereinbefore, the transport mode, also commonly known as transportation mode or travel mode, is determined by the terminal 104 and indicated to the system 114. Alternatively, the system 114 or external service 118 connected thereto may be configured to determine the transport mode based on data received from the terminal 104, such as sensor, time and/or location data.

A proprietary or some existing determination method may be applied. In particular, inertial sensor data such as accelerometer, gyroscope and/or magnetometer data may be exploited in the procedure yielding an estimate of the used transport mode, such as walking, bus, metro, tram, train, bicycle, aerial transportation, waterborne transportation, or car (e.g. taxi). The sensor data may be provided to a classifier, such as neural network—based classifier, which outputs an indication of the most likely transport mode.

Generally, but not as a of limitation to applicable methods, the transport(ation) (travel) mode could be determined based on at least one available element selected from the group consisting of: location data, satellite positioning data, network data, cell identification data, Wi-Fi hotspot (access point) data, camera image data, sound data, read tag data, time data, calendar date, time of the day, day of the week, inertial sensor data, accelerometer data, transport service route information, and transport service schedule.

Calendar or time type information as well as service route or service schedule data could be generally applied to filter out or minimize the probabilities of the modes that turn out practically impossible in the estimated location of the terminal at the assessed instant (particular date, day, time, etc.). For example, if it is known that at some particular time of each day, e.g. during the night, the metro is generally closed, it may be omitted from the potential list of used transport modes regarding the known period. A similar approach may be selected for utilizing available route information. If the location of the user is known to be very distant from any metro line, metro is not even initially relevant to mode determination close to that particular location.

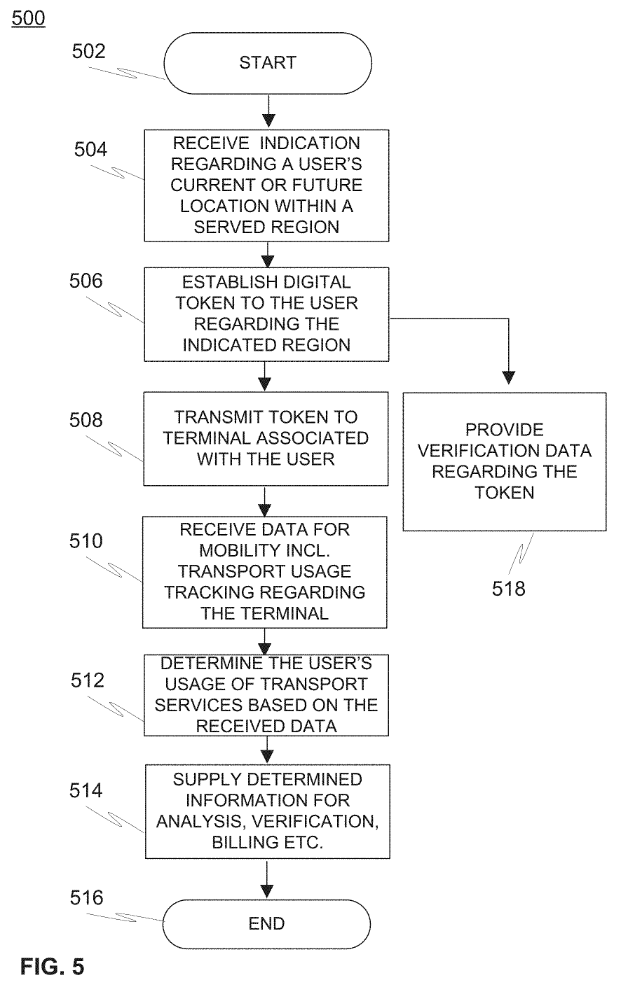

Instead of or in addition to utilizing available, known transport service route or schedule data already during transport mode determination, it could be utilized e.g. by the mobility system 114 in determining (identifying, for example) more detailed characteristics of the used transport services, e.g. particular transport line such as bus line (e.g. ‘line 493’). Accordingly, the transport mode could be determined at least primarily based on sensor data such as inertial sensor data. This issue will be contemplated further in connection with the description of FIG. 5.

Optionally together with time and location data, the transport mode estimate may be nevertheless utilized in determining (identifying and/or otherwise characterizing) the used transport services. The available location and preferably also time data may be used to determine, with further reference with e.g. available transport service (e.g. public transportation) route and/or schedule data, the most likely transport service used at various instants during the user's journey in the region.

Time and related location data may be optionally used to filter out impossible transport modes having regard to e.g. two estimated locations of the terminal 104/user 102 and time spent for moving between them. If the determined time duration is e.g. so short that it renders some mode such as walking practically impossible, the identified transport mode is not considered and the likelihood of remaining transport modes utilizing faster ways of traveling is only estimated based on e.g. inertial sensor data and/or transport service route and/or schedule data.

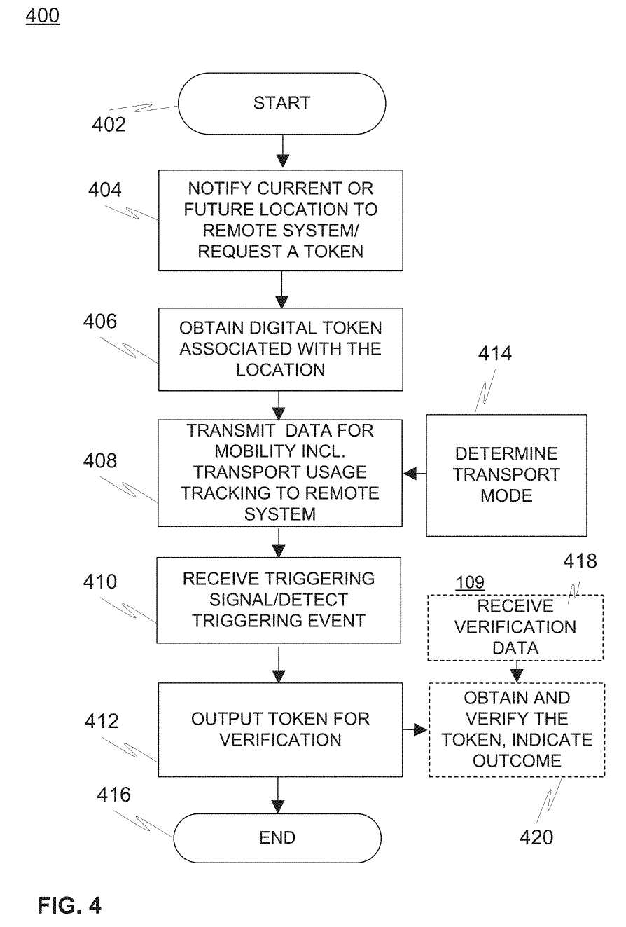

FIG. 4 is a flow chart of a method according to an embodiment of the invention. Although the shown diagram contains a plurality of definite method items, in various other embodiments all the same items do not have to present. There may be additional method items as well, which are not shown in the current figure. The items depicted using broken lines are typically executed by a verification apparatus whereas the other items are preferably executed by an embodiment of the electronic mobile user terminal device.

At method start-up 402, different preparatory tasks may be executed. For example, the user subscribes to the token management service operated by the token management system. The mobile user terminal is configured by installation and execution of e.g. appropriate software for enabling token reception and storing, indication, and potential further related tasks such as trip planning and/or navigation.

At 404, current or future location is preferably indicated to the remote mobility management system by the terminal for obtaining a related token capable of being used as digital proof of the user's subscription to the system, which authorizes the user to utilize transport services in the region containing the location.

At 406, the digital token established by the remote mobility management system is received and stored at the user terminal. The token contains digitally signed data as deliberated hereinbefore. The token exhibits a temporally limited right to utilize the transport services within the region. The applicability of the token may be further geographically limited to the particular region.

Accordingly, signing data such as signing key (e.g. a private key) associated with the mobility management system and used for establishing the digital signature as well as verification data used by the verification apparatuses to verify the token may be region-specific and preferably thus exclusive to the region in question. Preferably, signing data such as the private key is, however, not included in the token.

Item 408 refers to transmitting a number of wireless signals including signals indicative of the times and corresponding locations of terminal to the management system to facilitate the system keeping track of the movement and related usage of transport services by the user in the region. The activities underlying item 408 may thus remind of the item 404, still depending on the embodiment, but take place after initially receiving the token.

A single signal, e.g. a message, may indicate one or several time-location associations (in the case of the latter option, at least the ones preceding the most current association being thus buffered in the terminal, indicative of locations visited earlier during the journey). As contemplated hereinbefore, the transmission instants and/or intervals of such signals may be substantially fixed or dynamic, i.e. altered based on various conditions. In the lack of e.g. network coverage required for duly executing the transmissions substantially in real-time fashion or when otherwise considered feasible, time-location data may be buffered for delayed, e.g. batch type, transmission.

Further data that may be sent include e.g. sensor data and/or transport mode indications if locally determined at 414 by the terminal. The transport mode determination may generally take place e.g. upon receipt of necessary (predefined) amount of new sensor data, for instance. This may be also applied to mode determination executed by the mobility management service instead of the terminal.

At 410 e.g. user input or interrogation signal (e.g. a token request message of predefined structure) is received at the terminal, responsive to which, at 412, the token including said digitally signed data is wirelessly indicated, e.g. optically by means of the display or using radio frequencies, to a proximate verification apparatus (fixed or mobile and carried by inspector, for instance) to enable the verification apparatus to inspect the user's subscription as indicated by the token data and check the authenticity of the signature through the application of verification data provided by the system and stored in the apparatus.

The interrogation signal may herein refer to e.g. a pilot signal of advisory nature or some other signal of the verification apparatus. In other words, the signal does not have to, but it still may, expressly request a token from the user terminal. Generally, a verification apparatus may be thus detected to reside in range by the receipt of such signal, which may trigger further communication therewith including the transmission of the token. The verification apparatus could be detected also otherwise, potentially optically based on e.g. image data obtained from the camera of the user terminal and subjected to pattern recognition. As a further example, a characterizing sound emitted by a close verification apparatus could be detected by the microphone of the user terminal.

As thoroughly discussed herein earlier, verification data may include e.g. public key element of private key-public key functional pair associated with the mobility management system, wherein the private key has been already used to establish the signature through encryption.

Item 418 refers to the receipt of verification data at verification apparatus. The verification data such as the aforementioned public key and e.g. (signing) certificate regarding the mobility management system, may be received directly from the management system or via e.g. a server of the system of the transport provider.

Item 420 refers to receiving token data from the terminal at the verification apparatus e.g. optically or using radio frequencies, and validating the token against the received verification data. The outcome of such check may be indicated locally via the display or other UI features of the apparatus and/or indicated wirelessly to the mobile terminal using e.g. radio frequencies for possible local indication thereat using e.g. the display screen. Yet, the verification apparatus may store a log entry regarding the verification action and/or transmit an indication thereof to a remote system such as a network server of the transport provider system for remote logging and/or analysis, for example. An indication of the verification action could be further indicated to the mobility management system by the transport provider (e.g. directly by the concerned verification apparatus or by a centralized entity such as a server of the transport provider system).

Item 416 refers to the end of method execution. It is easily contemplated by a skilled person that many of the shown items may be repeatedly executed e.g. at different instants. For example, item 408 already exhibits the fact that several time +location associations may be transmitted during the journey of the user, typically from different locations as the user moves utilizing e.g. the available transport services. Accordingly, as the locations may belong to different regions from the standpoint of mobility management (e.g. in view of transport services offered and/or related transport operators), also new or updated tokens may be dynamically issued and received at the user terminal during the particular trip or reporting period.

FIG. 5 is a flow chart of a method according to another embodiment of the invention.

At 502, different preparatory actions may be executed. The mobility management system primarily intended for executing the method may be configured to enable communication with a number of transport provider systems, potential other external systems and e.g. mobile user (subscriber) terminals. The system typically covers several different geographical regions (service regions), which may be visited by the users carrying mobile terminal devices. The system operates in liaison with local transport providers providing passenger transport services in the regions.

User accounts may be established to the users including related account information such as user ID, terminal ID, service level information, usage history data, password (e.g. in hashed or generally encrypted format), other credentials, e.g. biometric information, and/or payment/billing information. Such data may be later applied in token creation, for example.

At 504, an indication of a user's location is received, different possible aspects of which have been already contemplated hereinbefore. For example, the mobile user terminal may establish and send a location estimate as a wireless signal, or the location may be determined by using e.g. triangulation based on the signals transmitted by the terminal. The indication may refer to the current or future (recalling the travel plan aspects) location of the terminal and the associated user.

At 506, a digitally signed token is established to the user carrying the terminal for use as a digital proof of the user's subscription to the system, wherein the token exhibits temporally limited default right to utilize the transport services offered via a local transport provider within a region of typically several regions covered by the system. The ‘default right’ refers herein to mutual trust-implicating configuration of the mobility management system and system of the transport provider (as well as related verification apparatuses) to communicate token data between them and based on successful verification of user terminal carried token, authorization of the user by the transport provider to utilize the transport services within the region without relying on prior art type advance payment—requiring travel ticket arrangements.

Again, besides temporal validity limitation, the applicability of the token may be specifically limited to the particular region in question. The signing data such as private signing key and related verification data, such as public key, may be region-specific as discussed in connection with the description of e.g. FIG. 4.

At 508, the digitally signed token is transmitted to the mobile terminal of the user.

Item 518 refers to providing the necessary verification data, such as public key and e.g. certificate for enabling signature and thus token validation, to the transport provider. The used provision mechanism may refer to any applicable, preferably digital, communication mechanism such as transmission of the verification data over a communication connection, e.g. over the Internet or some other communication network. A centralized entity such as a server of the transport provider may then forward the received verification data to the verification apparatuses. Alternatively, the data is directly sent by the mobility management system to the target verification apparatuses. As a further alternative, a centralized entity may store at least part of the verification data that is afterwards, e.g. in substantially real-time fashion, accessed by the verification apparatuses to execute verification tasks. The last option requires sufficient network coverage, however.

Item 510 refers to receiving signals transmitted by and/or at least regarding the device, including signals indicative of the times and corresponding locations of the user terminal device. The received signals may further indicate e.g. transport mode determinations already performed by the terminal and/or sensor data collected by the terminal.

At 512, the data included in the received signals is utilized for determining the user's usage of transport services within the region. In case the received data is silent on transport modes but includes e.g. necessary sensor data for determining such, the system may be configured to determine the likely transport modes based on the received data.

As discussed hereinbefore, based on available data regarding the locations/routes of different transport services and e.g. their schedules, points in time of the terminal at different locations, and the estimated transport modes, various characteristics of the used transport services (e.g. bus line, boat or other waterborne vessel line, tram line, train line, underground line, air connection (e.g. fixed wing and/or rotorcraft), and/or taxicab or private car leg) within the region and within a desired inspection period such as a reporting period may indeed be identified.

These data may be optionally determined user-specifically but then reported collectively, depending on the particular reporting requirements set by the transport provider, for example.

At least one characteristic to be identified may be selected from the group consisting of: the used transport lines, the used transport modes, number of modes used, number of transport lines used, number of times a transport line used, aggregate duration of transport line used, aggregate duration of transport mode used, number of transport line stop intervals travelled, and transport zones used (the region may contain several zones the borders of which may be passed during travel within the region).

For example, if an obtained location or route (of several subsequent location estimates) estimate of the user (terminal) substantially responds to a stop or route of a bus line, respectively, and based on sensor data/transport mode data, the user may be traveling on a bus, the user is deemed to have traveled using that particular bus line. Further, schedule and generally temporal data may be used in the determination. It may be verified, for instance, that at the time instants associated with the location estimates the bus line was really active in the area.

At 514, the result of the analysis e.g. in the form of a report type data ensemble or generally some other desired kind of a deliverable, involving e.g. statistics and/or logged events such as time/position data, is supplied to the transport provider for analysis, verification, and/or billing purposes, for example, preferably in digital format. The adopted supply mechanism depends on the embodiment and may refer to e.g. transmission over available communication connection (e.g. the Internet or other communication network) or online publication e.g. on a web site optionally hosted by the system or third party.

As mentioned hereinabove, the resolution of the report may vary depending on the embodiment, i.e. may separate between individual users and their transport service utilization history and/or provide aggregate statistics (e.g. how many users in total utilized a transport line such as bus line ‘153’ during a reporting period and how extensive was that use, e.g. how many times and/or how long was the line used). The deliverable may alternatively concern a single user only.

The method execution is ended at 516. As with the embodiment of FIG. 4, the execution of various shown method items may be and often are repeated upon need as being understood by a person skilled in the art. For example, new or updated (refreshed) token may be issued 506 and transmitted 508 responsive to e.g. a location indication received implying a switchover from a region to another. Generally, in case the user terminal already contains a token that has some valid data that could be spared for the next token (i.e. common data with the new token), in some embodiments only the necessary (e.g. changed and/or new) data could be signaled at 508 to the terminal instead of all token data. Likewise, upon expiry of a token, a new token may be provided or the existing one revised provided that the user remains within the region based on e.g. obtained location estimate or token (renewal) request received.

The scope is defined by the attached independent claims with appropriate national extensions thereof having regard to the applicability of the doctrine of equivalents.

1. An electronic mobile communication terminal device for accompanying a user of the device while travelling in a geographic region served locally by at least one transport provider, such as a transport authority and/or transport operator, offering passenger transport such as public transport services therein, said terminal device comprising a wireless data transfer interface to transmit and receive data, at least one processor, and at least one memory storing instructions that, when executed by the at least one processor, cause the terminal device to
receive and store a digital token containing digitally signed data and issued by a remote mobility management system trusted, by default, by the transport provider, said token being allocated to the user as a digital proof of the user's subscription to the system, wherein the token exhibits a temporally limited right to utilize the transport services within the region, said signed data being optionally established using a private signing key associated with the system,
transmit a number of wireless signals, preferably over a cellular or wireless local area network, to the system, including signals indicative of the times and corresponding locations of device during the user's stay within the region to facilitate the system keeping track of the movement and related usage of transport services in the region by the user, and
indicate, responsive to a triggering event, the token including said digitally signed data wirelessly to a proximate verification apparatus associated with the transport provider, optionally other electronic mobile communication terminal device carried by an inspector or a stationary or vehicle-installed verification apparatus, to enable the verification apparatus to inspect the user's subscription based on the indicated token data and check the authenticity of the signature through the application of verification data associated with the system and preferably stored in the apparatus, said verification data optionally including a public key associated with the system.

2. The device of claim 1, comprising a display screen, said device being configured to indicate the token to the verification apparatus optically via the display screen, optionally using displayed numeric characters, alphabetic characters, alphanumeric characters and/or graphical code such as a matrix code, to enable optical reading thereof by the verification apparatus, preferably by the camera of the apparatus.

3. The device of claim 1, configured to indicate the token to the verification apparatus utilizing short-range wireless radio frequency technology, optionally RFID, NFC, other radio frequency tag, infrared, sound, ultrasound, Bluetooth, or Bluetooth low energy compliant technology.

4. The terminal device of claim 1, wherein the token comprises or indicates at least one element selected from the group consisting of: user ID, anonymous or anonymized user ID, device ID, signature established using a private key associated with the system, signature including a message digest obtained through hashing at least part of the token data content, expiry time, start time, duration of validity, region of validity, shared secret such as symmetric key, issuer ID, image characterizing the region and/or transport provider, graphical theme characterizing the region and/or transport provider, and biometric evidence, optionally including a photograph or fingerprint data, representing the user.

5. The terminal device of claim 1, configured to transmit, optionally automatically or responsive to predefined user input such as a token request, a wireless notification signal indicative of the current location to the management system, preferably in response to which the token specific to the region including said location is issued by the system and received in the device.

6. The terminal device of claim 1, configured to establish and transmit, as a wireless signal, a digital travel plan in accordance with the control input by the user to the management system, said plan being indicative of the user's visit to the region, preferably in response to which the token specific to the region is issued by the system and received in the device.

7. The terminal device of claim 1, wherein the triggering event contains at least one element selected from the group consisting of: receipt of user input via a user interface of the device instructing to indicate the token, detection of verification apparatus in range, and receipt of interrogation signal from the verification apparatus.

8. The terminal device of claim 1, configured to determine an indication of the current location based on at least one element selected from the group consisting of: satellite positioning signal, GPS signal, GLONASS signal, wireless network signal, cellular signal, wireless LAN signal, inertial sensor, camera image, camera view, tag signal received, and audio signal captured via a microphone.

9. The terminal device of claim 1, configured to determine the transport mode of the user and include mode information in the transmitted wireless signals, wherein mode information is determined based on at least one element selected from the group consisting of: sensor data, inertial sensor data, accelerometer data, magnetometer data, gyroscope data, location data, satellite positioning data, network data, cell identification data, Wi-Fi hotspot data, image data, sound data, wirelessly read tag data, time data, calendar date, time of the day, day of the week, transport service route information, and transport service schedule.

10. The terminal device of claim 1, configured to determine the transport mode of the user and include mode information in the transmitted wireless signals, wherein mode information is determined based on at least one element selected from the group consisting of: sensor data, inertial sensor data, accelerometer data, magnetometer data, gyroscope data, location data, satellite positioning data, network data, cell identification data, Wi-Fi hotspot data, image data, sound data, wirelessly read tag data, time data, calendar date, time of the day, day of the week, transport service route information, and transport service schedule, further wherein the determined mode information indicates at least one element selected from the group consisting of: road transport, water transport, rail transport, passenger car, bus, boat or ferry, tram, train, underground, walking, running, cycling, time of getting aboard, time of getting off, leg duration, number of transport line stops such as bus stops, number of stop intervals, day of the week, calendar date.

11. The terminal device of claim 1, wherein the transmitted wireless signals incorporate sensor data preferably including inertial sensor data, such as accelerometer, gyroscope and/or magnetometer data, to enable determining the transport mode of the device remotely.

12. (canceled)

13. The terminal device of claim 1, configured to buffer time and location data, optionally also determined transport mode data, for wireless transmission optionally responsive to the availability of network coverage applicable for the transmission.

14. The terminal device of claim 1, configured to provide a route suggestion to a user-indicated destination from the current location and to provide related real-time navigation guidance in the form of visual and/or audible cues.

15. The device of claim 1, configured to provide a route suggestion to a user-indicated destination from the current location and to provide related real-time navigation guidance in the form of visual and/or audible cues, the terminal device being further configured to include one or more legs in the suggested route, said legs involving the use of applicable transport services, wherein the applicability of a transport service, such as bus, tram, metro, minibus, aircraft, boat, or train, for travelling a leg of the suggested route is determined based on at least one element selected from the group consisting of: time of the day, day of the week, calendar, transport service route, transport service schedule, current time, traffic situation, distance to be travelled, and weather information.

16. The device of claim 1, configured to inactivate or delete the token responsive to detection of a fulfillment of at least one condition selected from the group consisting of: token expiry, exit from the region, receipt of revocation signal, and occurrence of other revocation event.

17. An electronic system for providing digitally assisted personal mobility management service to users, wherein the system covers a number of different geographic regions and operates in liaison with one or more transport providers offering passenger transport services in said regions, said system further being communication network accessible, preferably Internet accessible, and comprising one or more at least functionally connected servers, said system comprising a data transfer interface to transmit and receive data via a communication network, at least one processor, and at least one memory storing instructions that, when executed by the at least one processor, cause the system to
establish a digitally signed token to a user carrying a mobile communication terminal device for use as a digital proof of the user's subscription to the system, wherein the token exhibits a temporally limited default right to utilize the transport services offered by at least one transport provider within a region of said number of regions,
transmit said digitally signed token to the device of the user,
provide digital verification data to the transport provider to enable checking the authenticity of the signature,
receive signals transmitted by and/or regarding the device, including signals indicative of the times and corresponding locations of the device,
determine based on the received signals information characterizing the usage of the transport services within the region by at least said user during the validity of the token, and
supply the determined usage information, preferably by sending it in digital form or providing digital access thereto, to the transport provider preferably for analysis, verification, and/or billing purposes.

18. The system of claim 17, wherein signing data, such as a private signing key associated with the system, used for signing and verification data, such as a public key associated with the system, are region-specific.

19. The system of claim 17, configured to determine the transport mode of the user based on the received signals, optionally including sensor signals, wherein mode information is determined based on at least one element selected from the group consisting of: sensor data, inertial sensor data, accelerometer data, magnetometer data, gyroscope data, location data, network data, cell identification data, Wi-Fi hotspot data, camera or generally image data, sound data, wirelessly read tag data, time data, calendar date, time of the day, day of the week, transport service route information, and transport service schedule.

20. The system of claim 17, configured to determine or receive transport mode information indicative of at least one element selected from the group consisting of: road transport, water transport, rail transport, passenger car, bus, boat or ferry, tram, train, underground, walking, running, bus line, boat line, tram line, train line, underground line, time of jumping aboard, time of jumping off, leg duration, number of transport line stops, number of stop intervals, day of the week, calendar date.

21. The system of claim 17, configured to determine, based on the location data and transport mode data received or derived based on the data such as inertial sensor data, at least one characteristic regarding the user's usage of the transport services, optionally having regard to a selected analysis period such as the validity period of the token or a selected reporting period, said characteristic being selected from the group consisting of: used transport lines, used bus line, used boat or other waterborne vessel line, used tram line, used train line, used airborne connection, used private car or taxicab leg, the used transport modes, number of modes used, number of transport lines used, number of times a transport line used, aggregate duration of transport line used, aggregate duration of transport mode used, number of transport line stop intervals travelled, and transport zones visited.

22. The system of claim 17, configured to supply the determined usage information as embodied in a digital report or other data ensemble, wherein the report or other data ensemble preferably covers usage data of also a number of other users active in the region during an analysis period such as the validity period of the token or a longer period spanning a plurality of token validity periods, said analysis period optionally covering one week or month.

23. (canceled)

24. The system of claim 17, configured to establish and transmit the token in response to receiving a digital travel plan or a notification signal indicative of the user's current or forthcoming presence in the region, optionally transmitted by said terminal device of the user.

25. The system of claim 17, configured, in response to receiving a signal indicative of the user's stay within the region extending beyond the expiry of the token, to establish a new token with expiry farther away in the future or extend the expiry of the existing token to the user.

26. The system of claim 17, configured to provide a reply signal indicative of the user's subscription status in response to a receipt of a subscription validity query from a remote element, optionally the transport provider.

27. (canceled)

28. A method to be executed by an electronic mobile personal communication device carried by a user of the device while travelling in a region served by at least one transport provider, said method comprising:
receiving and storing a digital token containing digitally signed data and issued by a remote mobility management system trusted, by default, by the transport provider, said token being provided to the user as a digital proof of the user's subscription to the system, wherein the token exhibits temporally limited right to utilize the transport services within the region,
transmitting wireless signals including signals indicative of the times and corresponding locations of device to the management system to facilitate the system keeping track of the movement and related usage of transport services in the region by the user, and
indicating, responsive to a triggering event, the token including said digitally signed data wirelessly to a proximate verification apparatus to enable the verification apparatus to inspect the user's subscription as indicated by the token data and check the authenticity of the signature through the application of verification data associated with the system and preferably stored in the apparatus.

29. A method to be executed by an electronic system for providing digitally assisted personal mobility management service to users, wherein the system covers a number of different geographical regions and operates in liaison with transport providers offering passenger transport services in the regions, said system further being communication network accessible and comprising one or more at least functionally connected servers, said method comprising:
establishing a digitally signed token to a user carrying an electronic mobile personal communication device for use as a digital proof of the user's subscription to the system, wherein the token exhibits temporally limited default right to utilize the transport services offered by at least one transport provider within a region of said number of regions,
transmitting said digitally signed token to the device of the user,
providing verification data to the transport provider, to enable checking the authenticity of the signature,
receiving signals transmitted by and/or at least regarding the device, including signals indicative of the times and corresponding locations of the device,
determining based on the received signals information characterizing the usage of the transport services by at least said user within the region during the validity of the token, and
supplying the determined usage information to the transport provider preferably for analysis, verification, and/or billing purposes.

30. (canceled)

31. (canceled)
